(19) United States
(12) Patent Application Publication
(10) Pub. No.: US 2026/0238145 A1
(43) Pub. Date: Aug. 13, 2026

(54) MOTOR SYSTEM

(71) Applicant: MURATA MACHINERY, LTD., Kyoto-shi, Kyoto (JP)

(72) Inventors: Daisuke Fukushima, Inuyama-shi, Aichi (JP); Yoshiyuki Azuma, Inuyama-shi, Aichi (JP)

(73) Assignee: MURATA MACHINERY, LTD., Kyoto-shi, Kyoto (JP)

(21) Appl. No.: 18/724,368

(22) PCT Filed: Nov. 17, 2022
(86) PCT No.: PCT/JP2022/042777

§ 371 Date: Apr. 21, 2026

(30) Foreign Application Priority Data
Dec. 27, 2021 (JP) 2021-213560

(51) Int. Cl. H02P 5/74

(52) U.S. Cl. CPC H02P 5/74

(57) ABSTRACT

A motor system (1) includes a plurality of motors (23), a motor driver (21), and a switcher (22). The motor driver (21) generates and outputs a drive waveform to make the plurality of motors (23) generate a driving force by PWM control. The switcher (22) selectively switches the target motor (23), to which electric power output by the motor driver (21) is supplied, among the plurality of motors (23). The switcher (22) is controlled by a switching controller (43) so that the target motor is cyclically switched among the plurality of motors (23). A carrier cycle of the PWM control includes a low-level period during which the PWM output is low level. The switching controller (43) controls the switcher (22) so that the switcher (22) switches the target motor during the low-level period.

### TECHNICAL FIELD

The present invention relates to a motor system in which a motor driver drives a plurality of motors.

### BACKGROUND ART

Conventionally, motor systems are known that distribute electric power output by a motor driver to a plurality of motors in a time-slicing manner. PTL 1 discloses this type of motor system.

In the motor driver disclosed by PTL 1, a plurality of motors are connected to only one motor driver via a switching circuitry. The motor driver controls the on/off of six transistors to apply the appropriate voltage to each of the U, V, and W phase drive coils provided by each motor. Each transistor is driven by a pulse signal using a pulse width modulation scheme. By operating of an appropriate switching circuitry, the plurality of motors are driven simultaneously.

### PRIOR-ART DOCUMENTS

### Patent Documents

PTL 1: Japanese Patent Application Laid-Open No. 2007-288964

### SUMMARY OF THE INVENTION

### Problems to be Solved by the Invention

In the configuration of above PTL 1, there is a possibility that noise, surges, or the like may be generated at the timing when the switching circuitry performs switching.

The present invention is made in view of the above circumstances, and its purpose is to prevent the generation of noise, surges, etc. in a motor system in which electric power output by a motor driver is supplied to a plurality of motors while switching to drive them simultaneously.

### Means for Solving the Problems and Effects Thereof

The problem to be solved by the present invention is as described above, and next, means for solving the problem and effects thereof will be described.

According to an aspect of the present invention, a motor system with the following configuration is provided. That is, a motor system includes a plurality of motors, a motor driver, and a switcher. The motor driver generates and outputs a drive waveform to make the plurality of motors generate a driving force by PWM control. The switcher selectively switches a target motor, to which electric power output by the motor driver is supplied, among the plurality of motors. The switcher is controlled by a switching controller so that the target motor is cyclically switched among the plurality of the motors. A carrier cycle of the PWM control includes a high-level period during which the PWM output is high level and a low-level period during which the PWM output is low level. The switching controller controls the switcher so that the switcher switches the target motor during the low-level period.

This effectively prevents noise and surges, etc. from being generated during the switching operation of the switcher.

In the motor system described above, it is preferred that the switching controller controls the switcher so that the switcher switches the target motor at a timing where a phase of the carrier cycle differs by 180° with respect to a central timing of the high-level period.

This allows the switcher to perform the switching operation at precise timing in relation to the PWM control.

In the motor system described above, the following configuration is preferable. That is, the switching controller controls the switcher so that the target motor is switched at each predetermined switching cycle. The carrier cycle of the PWM control and the switching cycle are synchronized.

This allows the switcher to perform the switching operation at precise timing in relation to the PWM control.

In the motor system described above, the following configuration is preferable. That is, the motor system includes a voltage detector that detects a voltage output from the motor driver. The switching controller determines a switching timing included in the low-level period based on the detection result of the voltage detector. The switching controller controls the switcher so that the switcher switches the target motor at the switching timing.

This allows the switcher to perform the switching operation at precise timing in relation to the PWM control, without requiring a special configuration of the motor driver.

In the motor system described above, the following configuration is preferable. That is, each of the plurality of motors includes coils corresponding to a plurality of phases. The motor driver performs the PWM control for each of the coils of the plurality of phases. The switching controller determines a central timing of the past high-level period of the PWM output for at least one of the plurality of phases. The switching controller determines the switching timing based on the central timing.

This allows a predetermined timing included in the low-level period to be acquired as the switching timing.

In the motor system described above, the following configuration is preferable. That is, the switching controller determines a central timing of the past high-level period of the PWM output for two or more of the plurality of phases. The switching controller determines the switching timing based on the central timings determined for two or more phases.

This allows the switching timing to be stably acquired even in situations where the motor driver performs PWM output at various duty ratios for each phase.

In the motor system described above, the following configuration is preferable. That is, each of the plurality of motors includes coils corresponding to a plurality of phases. The motor driver performs the PWM control for each of the coils of the plurality of phases. The switching controller controls the switcher so that the switcher switches the target motor during a period when the PWM output is low level for all of the plurality of phases.

This effectively prevents noise, surges, and the like from being generated during the switching operation of the switcher, in all of the plurality of phases where PWM control is performed.

### BRIEF DESCRIPTION OF THE DRAWINGS

FIG. 1 is a block diagram of a motor system according to one embodiment of this invention.

FIG. 2 is a schematic diagram showing a motor driver and a switcher.

FIG. 3 is a graph showing a relationship between a PWM control performed in the motor driver and switching of a target motor by the switcher.

FIG. 4 is a schematic diagram showing the switcher in a state switched from FIG. 2.

FIG. 5 is a schematic diagram illustrating a computation of switching timing of switch elements in a switching controller.

### EMBODIMENT FOR CARRYING OUT THE INVENTION

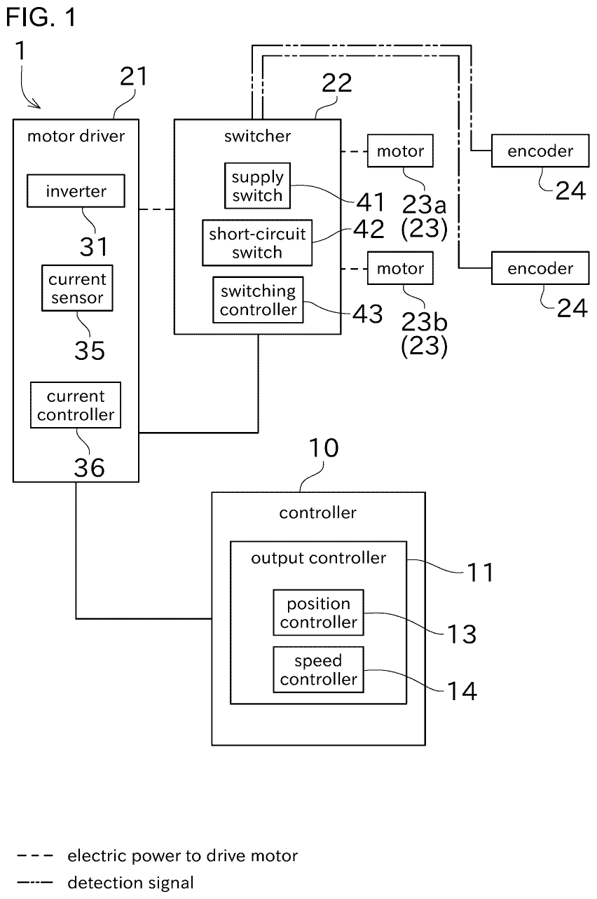

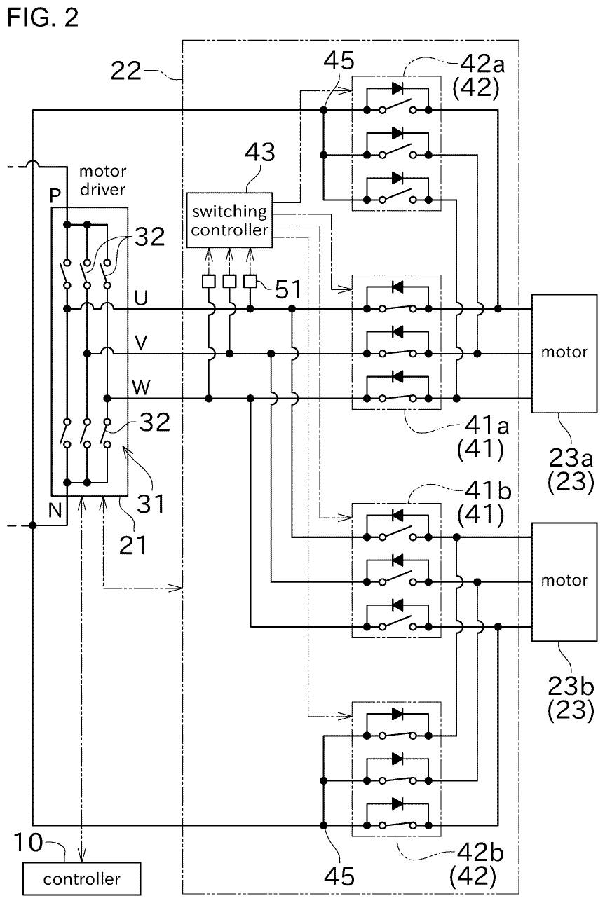

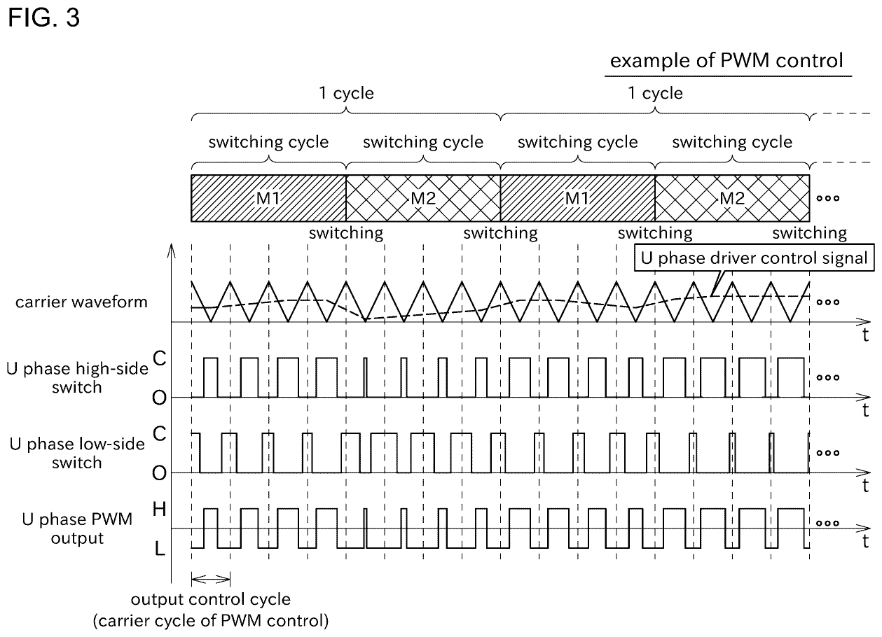

Next, an embodiment of this invention will be described with reference to the drawings. FIG. 1 is a block diagram of this embodiment of a motor system 1. FIG. 2 is a schematic diagram showing a motor driver 21 and a switcher 22. FIG. 3 is a graph showing a relationship between the PWM control performed in the motor driver 21 and the switching of a target motor by the switcher 22.

The motor system 1 is a system for controlling a plurality of motors 23. As shown in FIG. 1, the motor system 1 includes a controller 10, a motor driver 21, a switcher 22, the plurality of motors 23, and a plurality of encoders 24.

The controller 10 controls the plurality of motors 23 via the motor driver 21 and the switcher 22. The configuration of the controller 10 will be described later.

The motor driver 21 supplies electric power to the plurality of motors 23 to operate these motors 23. The motor driver 21 is, for example, a servo amplifier or inverter. The motor driver 21 is electrically connected to the controller 10 and can send and receive signals.

The motor driver 21 is controlled by the controller 10. The motor driver 21 includes an inverter 31. The inverter 31 generates a drive waveform in response to the output of the controller 10. The motor driver 21 outputs the voltage based on the acquired drive waveform to the switcher 22. The detailed configuration of the inverter 31 will be described later.

The motor driver 21 has a current sensor (current detector) 35 and a current controller 36.

The current sensor 35 detects magnitude of the current supplied from the motor driver 21 to the motor 23. The motor driver 21 outputs a current value which is the detection result of the current sensor 35 to the controller 10.

The current controller 36 controls the inverter 31 to generate the drive waveform for the motor 23 in response to a signal input from an output controller 11 which will be described later, included in the controller 10. Details of the current controller 36 will be described later.

The switcher 22 selectively supplies the electric power output by the motor driver 21 to the plurality of motors 23. The switcher 22 is in connection with the controller 10 via the motor driver 21 for communication and can send and receive signals. In this embodiment, the motor driver 21 and the switcher 22 are provided in a one-to-one correspondence. However, the motor driver 21 and the switcher 22 may correspond one-to-many or many-to-one instead of one-to-one.

The motor driver 21 is connected to an input side of the switcher 22. The plurality of motors 23 are connected to an output side of the switcher 22 respectively. The number of motors 23 is arbitrary as long as plural, but in this embodiment, there are two. In the following, each of the two motors 23 may be referred to as first motor 23a and second motor 23b to identify each of them.

The switcher 22 is configured as a circuit including a plurality of switches. The switcher 22 is mounted on a board, for example.

The switcher 22 includes a supply switch 41, a short-circuit switch 42, and a switching controller 43. When the switching controller 43 switches the supply switch 41 and the short-circuit switch 42, the motor 23 to which electric power is supplied is switched. Hereinafter, the motor 23 to which the electric power is supplied may be referred to as target motor.

The switcher 22 switches the supply switch 41 and the short-circuit switch 42 due to the control of the switching controller 43, so that the target motor is switched between the first motor 23a and the second motor 23b.

At a given moment, the target motor to which electric power is supplied is only one of the plurality of motors 23 connected to the switcher 22, i.e., any of the first motor 23a and the second motor 23b. The switching controller 43 controls the switcher 22 so that the switcher 22 repeats a cyclical switching operation of the target motor between the two motors 23 at high speed. This allows the two motors 23 to be driven substantially simultaneously.

When switching the target motor, the switching controller 43 controls the operation timing of the supply switch 41 and the short-circuit switch 42 to be in a specific relationship to PWM output of the motor driver 21. Details of the control of the operation timing of the switches will be described later.

The motors 23 can be configured, for example, as three-phase or two-phase motors. Each of the motors 23 has a stator and a mover. Preferably, one of the stator and the mover includes permanent magnets and the other contains a coil. The coil becomes an electromagnet when electric power is supplied to the coil from the motor driver 21. This causes a repulsive or attractive force between the stator and the mover, resulting in relative motion of the mover with respect to the stator. The motor 23 in this embodiment is a rotary motor in which the mover (rotation element, rotor) is in rotary motion relative to the stator (stationary element). A linear motor in which a mover moves (slides) in a linear motion with respect to a stator can also be used as the motor 23.

The encoder 24 is provided for each of the motors 23. The encoder 24 detects the operating state of the motor 23, in particular the relative displacement of the mover with respect to the stator.

In the case where the motor 23 is a rotary motor, the encoder 24 can be, for example, a known Hall element. The Hall element can detect the angle of rotation of the mover. In the case where the motor 23 is a linear motor, the encoder 24 can be, for example, a magnetic sensor installed on the path of movement of the mover. The magnetic sensor is capable of detecting the position of the mover relative to the stator.

The encoder 24 is electrically connected to the switcher 22 and can output a detection signal to the switcher 22. The detection result of the encoder 24 is transmitted to the controller 10 via the motor driver 21.

The controller 10 includes an output controller 11.

The controller 10 is configured as a known computer with, for example, a CPU, a ROM, a RAM, and an auxiliary storage device. The auxiliary storage device is configured as, for example, an HDD, an SSD, or the like. Various programs and the like are stored in the auxiliary storage device. By executing these programs, the controller 10 can perform various controls with respect to the motor system 1. Thus, through the cooperation of the hardware and the software, the controller 10 can function as the output controller 11.

The controller 10 may perform processes other than the control described above. Some or all of the output controller 11 may be realized by hardware that is physically different from the controller 10 (for example, the motor driver 21).

The output controller 11 generates and transmits a driver control signal to the motor driver 21. In this embodiment, the driver control signal is a signal of a current command output by a speed controller 14 described later. The motor driver 21 controls the duty ratio of the PWM control based on the current command and outputs it as PWM from the inverter 31.

The output controller 11 includes a position controller 13 and a speed controller 14.

The position controller 13 has the function of controlling a position of the mover for each of the motors 23. The position controller 13 compares, for example, a current position of the mover detected by the encoder 24 with a target position of the mover, and outputs a speed command to the speed controller 14 according to the position deviation.

The speed controller 14 has the function of controlling a speed of the mover for each of the motors 23. The speed controller 14 compares, for example, a current speed based on changes in the position of the mover detected by the encoder 24 with the speed command input from the position controller 13, and generates a current command corresponding to the speed deviation. The current command is a signal that indicates a current value. In this embodiment, this current command corresponds to the output of the output controller 11. This current command is input to the current controller 36 provided by the motor driver 21, as will be described later in detail.

Now, the operation of the current controller 36 included in the motor driver 21 in relation to the output controller 11 will be described. This current controller 36 determines a voltage command value of the PWM control for each of the motors 23.

The following is a detailed description focusing on the first motor 23a. The current controller 36 compares the current value acquired from the current sensor 35 with respect to the first motor 23a and the current command input from the motor system 1 (in other words, the speed controller 14 provided by the output controller 11), and computes a voltage to be applied for each phase coil of the first motor 23a according to the current value deviation. This calculation is based, for example, on known vector control. Thus, in this embodiment, the current value acquired by the current sensor 35 is used for feedback control.

The current controller 36 similarly determines a voltage to be applied for each phase coil of the second motor 23b.

The current controller 36 generates and outputs PWM voltage command values based on the voltages acquired from the computations. The voltage command value is generated for each of the three phases in the case where the plurality of motors 23 are, for example, three-phase motors.

In the controller 10, the output controller 11 operates at a constant cycle, resulting in a change in the current command. Hereafter, the above cycle which is the smallest unit of time in which the current command is controlled, may be referred to as output control cycle. The output control cycle coincides with the control cycle in which the voltage command is controlled in the current controller 36 of the motor driver 21.

As described above, the voltage output by the motor driver 21 is selectively supplied to the first motor 23a and the second motor 23b via the switcher 22 which repeats the cyclical switching operation. Correspondingly, the current command generated by the output controller 11 is a time-slicing composite of signals indicating current values for each of the first motor 23a and the second motor 23b, respectively.

As will be described later in detail, the inverter 31 provided by the motor driver 21 includes a number of semiconductor switch elements corresponding to the number of phases of the motor 23. When the voltage command value is input to the inverter 31 from the current controller 36, the inverter 31 opens and closes the switch elements repeatedly at high speed according to the known PWM control to achieve a duty ratio corresponding to the voltage command value. This allows the motor driver 21 to generate the drive waveform to drive the two motors 23 by distributing electric power to them in a time-slicing manner.

The output control cycle coincides with the carrier cycle of the PWM control performed by the motor driver 21. This allows the motor driver 21 to acquire a voltage waveform for good realization of the current command output by the controller 10 by the PWM control and supply it to the switcher 22.

In one cycle of switching the target motor between the two motors 23, the period during which electric power is supplied to one motor 23 is equal to the output control cycle or n times thereof (here, n is an integer greater than or equal to 2). This allows for substantial switching of control in conjunction with switching of the target motors.

Next, the motor driver 21 will be described in detail with reference to FIGS. 2 and 3. FIG. 2 schematically shows the circuit diagram of the motor driver 21 and the switcher 22. The current sensor 35 described above is omitted in FIG. 2.

As shown in FIG. 2, the motor driver 21 includes an inverter circuit. The inverter circuit converts DC voltage to three-phase AC voltage. The configuration of the inverter circuit is a full bridge type.

The inverter circuit has three legs corresponding to the three phases (U phase, V phase, and W phase) that the motor 23 has. Each leg includes two arms, and a switch 32 is located on each of the arms. The switches 32 are configured as semiconductor switch elements, as described above. For each of the switches 32, a return diode, not shown, may be connected in parallel.

The motor driver 21 has P and N terminals. A constant-voltage DC power supply, not shown, is connected to the P and N terminals. Therefore, the P and N terminals are terminals with constant potential. A positive side of the DC power supply is connected to the P terminal, and a negative side of the DC power supply is connected to the N terminal.

In the inverter circuit, for each of the U, V, and W phases, the switch 32 on the P terminal side and the switch 32 on the N terminal side are arranged forming a pair. The switch 32 on the P terminal side is referred to as high-side switch and the switch 32 on the N terminal side is referred to as low-side switch.

FIG. 3 shows an example of the PWM control by the motor driver 21 with respect to the U phase of the three phases.

In the graph in FIG. 3, the horizontal axis represents time. An interval between dashed lines arranged in the horizontal direction corresponds to the output control cycle. As mentioned above, the output control cycle coincides with the carrier cycle of the PWM control. M1 and M2 rectangles drawn at the top of the graph indicate the periods when the first motor 23a and the second motor 23b are the target motors, respectively.

FIG. 3 shows an example where the time period that electric power is supplied to each of the two motors 23 in one cycle corresponds to four cycles of the output control cycle, regardless of the motor. In other words, the switching operation of the switcher 22 causes the target motor to switch to another motor 23 between the two motors 23 every four cycles of the output control cycle. Hereafter, the cycle in which the switching operation is performed by the switcher 22 may be referred to as switching cycle.

FIG. 3 shows the open/closed state of the switch 32 on the P terminal side (high-side) and the switch 32 on the N terminal side (low-side) of the U phase, respectively. In the graph, C means closed state and O means open state.

The following is a description with reference to FIG. 3 focusing on the control of the U phase. In this embodiment of the motor driver 21, the switch 32 on the P terminal side and the switch 32 on the N terminal side are controlled to open and close in a complementary manner. When the switch 32 on the P terminal side is closed and the switch 32 on the N terminal side is opened, the output of the U phase is high level. When the switch 32 on the P terminal side is opened and the switch 32 on the N terminal side is closed, the output of the U phase is low level.

Strictly speaking, the timing at which the switch 32 on the P terminal side and the switch 32 on the N terminal side are switched is not simultaneous. That is, both switches 32 are open for a short time period to prevent a short circuit. This period is called dead time.

The PWM output of the U phase is shown in the lower part of FIG. 3. The waveform of this PWM output corresponds to the drive waveform. The PWM output reflects the switching of the two switches 32 open and closed. One carrier cycle of the PWM control includes a high-level period when the PWM output is high level and a low-level period when the output is low level. The duty ratio means a ratio of the length of the high-level period divided by the length of the carrier cycle.

The central timing of the pulse output in each carrier cycle of the PWM output substantially coincides with the central timing of that carrier cycle. The duty ratio change is achieved by increasing or decreasing the pulse time width while keeping the central timing of the pulses coincident with the central timing of the carrier cycle. This control can be achieved by using the well-known triangular wave comparison method for PWM control, and by making its carrier waveform a triangular wave whose minimum value is at the center of the carrier cycle and maximum value at the edge of the carrier cycle. In FIG. 3, the voltage of the carrier waveform is shown as a solid line and the voltage corresponding to the voltage command value is shown as a dashed line. At the timing when the two voltage signals intersect, the two switches 32 are switched.

In this control, at the end timing of the carrier cycle, the switch 32 on the P terminal side is always opened and the switch 32 on the N terminal side is always closed, except in special cases where the duty ratio is effectively 100%.

For the V and W phases, the switches 32 are controlled to open and close in the same manner as for the U phase, and the PWM output is generated. The carrier waveform used for PWM control is the same for the U, V, and W phases.

As described above, the inverter circuit converts the electric power supplied from the DC power source into AC electric power for the U, V, and W phases. As shown in FIG. 2, the motor driver 21 has output terminals for the U, V, and W phases. The AC voltage waveforms of the three phases corresponding to the converted electric power are output to the switcher 22 via these output terminals.

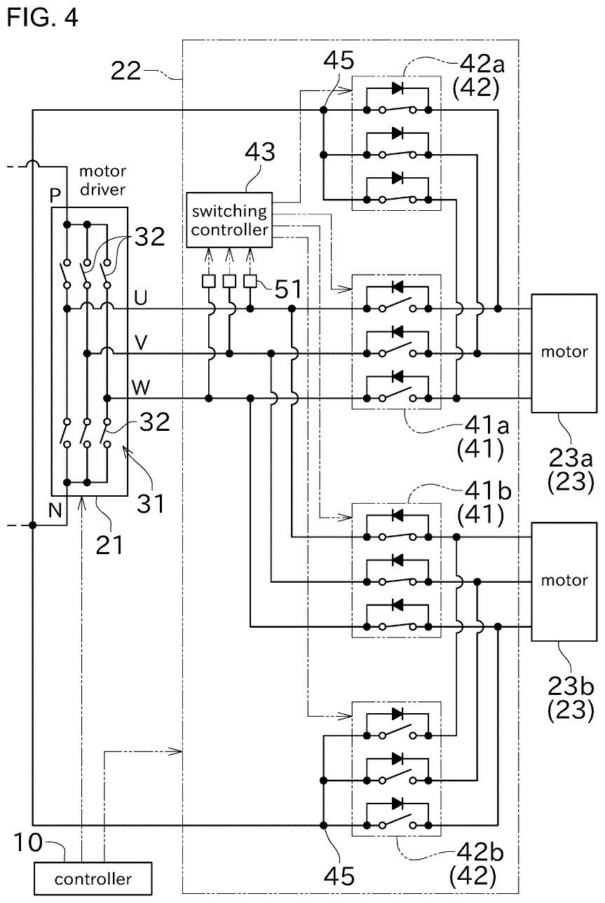

Next, the switcher 22 will be described in detail with reference to FIGS. 2 and 4.

The switcher 22 includes the supply switch 41 and the short-circuit switch 42, as shown in FIG. 2. In this embodiment, the switcher 22 includes a plurality of diodes, but all of these diodes can be omitted.

The supply switch 41 is provided for each of the motors 23. In order to identify each supply switch 41, the supply switch 41 corresponding to the first motor 23a may be referred to as first supply switch 41a and the supply switch 41 corresponding to the second motor 23b as second supply switch 41b.

A first side (left side in FIG. 2) of each supply switch 41 is connected to the motor driver 21. A second side (right side of FIG. 2) of each supply switch 41 is connected to the corresponding motor 23.

Each of the supply switches 41 has a configuration of a switch element and a diode connected in parallel. The diode allows current in the direction from the motor 23 to the motor driver 21 and blocks current in the opposite direction. Hereafter, the state in which the switch element is closed is referred to as transmission state and the state in which the switch element is opened is referred to as blocked state.

When the supply switch 41 is in the transmission state, current flows from the motor driver 21 to the corresponding motor 23. When the supply switch 41 is in the blocked state, no current flows from the motor driver 21 to the corresponding motor 23.

Since the plurality of motors 23 are all three-phase motors, in the supply switch 41, the switch elements and the diodes are provided for each of the U, V, and W phases. The same is true for the short-circuit switch 42 described later.

The short-circuit switch 42 is provided for each of the motors 23 in the same manner as the supply switch 41. In order to identify each short-circuit switch 42, the short-circuit switch 42 corresponding to the first motor 23a may be referred to as first short-circuit switch 42a and the short-circuit switch 42 corresponding to the second motor 23b as second short-circuit switch 42b.

A first side (right side in FIG. 2) of each short-circuit switch 42 is connected to a path between the corresponding motor 23 and the supply switch 41 connected to the motor 23. With respect to a second side (left side of FIG. 2) of each short-circuit switch 42, the U, V, and W phases are short-circuited at a short-circuit point 45.

Each of the short-circuit switches 42 has a configuration of a switch element and a diode connected in parallel. The diode allows current in the direction from the short-circuit point 45 to the motor 23 and blocks current in the opposite direction. Hereafter, the state in which the switch element is closed is referred to as transmission state and the state in which the switch element is opened is referred to as blocked state.

When the short-circuit switch 42 is in the transmission state, the U, V, and W phases are short-circuited. When the short-circuit switch 42 is in the blocked state, the U, V, and W phases are not short-circuited.

The second side (left side of FIG. 2) of each short-circuit switch 42 is connected directly or indirectly to the N terminal of the motor driver 21. Generally, if the U, V, and W phases are simply short-circuited, the potential will be unstable. However, by connecting the short-circuit side to the N terminal of the motor driver 21 as described above, the potential when short-circuited can be stabilized.

In any of the supply switch 41 and the short-circuit switch 42, a semiconductor switch element, such as a FET, can be employed as the switch element. FET is an abbreviation for field effect transistor.

The switch elements that the two supply switches 41 have and the switch elements that the two short-circuit switches 42 have are switched in conjunction with each other.

FIG. 2 shows the state in which the first motor 23a is the target motor. At this time, the three switch elements of the first supply switch 41a are in the transmission state and the three switch elements of the second supply switch 41b are in the blocked state. The three switch elements of the first short-circuit switch 42a are in the blocked state and the three switch elements of the second short-circuit switch 42b are in the transmission state.

FIG. 4 shows the state in which the second motor 23b is the target motor. At this time, the three switch elements of the first supply switch 41a are in the blocked state and the three switch elements of the second supply switch 41b are in the transmission state. The three switch elements of the first short-circuit switch 42a are in the transmission state and the three switch elements of the second short-circuit switch 42b are in the blocked state.

Between the state of FIG. 2 and the state of FIG. 4, the switch elements of the two supply switches 41 and the switch elements of the two short-circuit switches 42 are switched in conjunction with each other. By this operation, the switcher 22 can switch the target motor to which the motor driver 21 supplies electric power.

Next, the relationship between the switching timing of the target motor by the switcher 22 and the PWM control performed in the motor driver 21 will be explained.

As mentioned above, the electric power waveform of each phase of the motor driver 21 is generated by PWM control. Suppose, for example, that the switcher 22 switches from the state shown in FIG. 2 to the state shown in FIG. 4 while the U phase is high level of the PWM control.

The two supply switches 41 and the two short-circuit switches 42 are switched between the transmission state and the blocked state with a large potential difference between the output terminal of the U phase of the motor driver 21 and the N terminal. Therefore, there is a risk of noise, surges, or the like being generated as the switches are switched.

There is also a risk of self-turn-on phenomena accompanying the switching of the switches. The following is a detailed description.

Suppose, similarly as above, that the switcher 22 switches from the state shown in FIG. 2 to the state shown in FIG. 4 while the U phase is high level of the PWM control. The switching of the switcher 22 causes, for example, the switch of the U phase of the second short-circuit switch 42b to switch from the transmission state of FIG. 2 to the blocked state of FIG. 4. Since the switch of the U phase of the second supply switch 41b is switched to the transmission state, the potential of the first side in the switch of the U phase of the second short-circuit switch 42b changes from a low level potential to a high level potential. On the other hand, the potential on the second side of the second short-circuit switch 42b remains at a low level potential.

As described above, the switch elements of the supply switch 41 and the short-circuit switch 42 in this embodiment are configured as FETs. Here, consider the case where a known MOSFET is employed as the FET. MOS is an abbreviation for metal oxide semiconductor. A MOSFET has three terminals, which are called gate, drain, and source, respectively. The MOSFET switches between the transmission state and the blocked state between the source and the drain according to a signal input to the gate.

The MOSFET may unintentionally enter the transmission state due to the parasitic capacitance of the MOSFET itself when the voltage between source and drain changes sharply in a short period of time in the blocked state. This phenomenon is well known and is referred to as self-turn-on.

If the self-turn-on occurs on the switch element of the U phase of the second short-circuit switch 42b in the state shown in FIG. 4, then with respect to the U phase, the second supply switch 41b and the second short-circuit switch 42b are in the transmission state simultaneously. If the output of the motor driver 21 reaches a high level potential in this state, a large through-current flows through the two switch elements of the U phase, causing increased losses, increased heat generation, and damage to the switch elements.

In this regard, in this embodiment, as shown in FIG. 3, the operating timing for switching the target motor between the first motor 23a and the second motor 23b is controlled to coincide with a specific phase of the carrier cycle (specifically, the edge of the carrier cycle). This control is achieved by the switching controller 43 described above.

As mentioned above, in the PWM control performed by the motor driver 21 in this embodiment, the switch 32 on the P terminal side is opened and the switch 32 on the N terminal side is closed at the edge timing of the carrier cycle. In other words, at the edge timing of the carrier cycle, the output terminals of the U, V, and W phases of the motor driver 21 are all at the same potential as the N terminal. By switching the supply switch 41 and the short-circuit switch 42 at this timing, the generation of noise and surges can be effectively suppressed. In addition, in the case where the MOSFET is used as the switch element, a sudden change in the voltage between the source and drain of the MOSFET can be suppressed. As a result, self-turn-on of the MOSFET can be prevented, thus avoiding increased losses, heat generation, and damage to the switch element.

When the supply switch 41 and the short-circuit switch 42 perform the switching operation of the target motor, the switching controller 43 controls their operation timing to be included in the low-level period of the PWM output. This prevents noise and the like, and prevents the self-turn-on described above.

The switching controller 43 is a processing device. It is preferable for the switching controller 43 to be configured as a known FPGA or ASIC to achieve high-speed operation. Not limited to the above, the switching controller 43 can also be configured as a computer including a CPU, a ROM, a RAM, etc., for example.

The switching controller 43 monitors the voltage of each phase input from the motor driver 21. The switching controller 43 acquires the rising and falling timings of the voltage waveforms based on results of this monitoring, and computes the edge timing of the carrier cycle based on these timings. The edge timing of the carrier cycle can be rephrased as a timing that deviates from the central timing of the high-level period of the PWM output by a time equivalent to 180° of the phase of the carrier cycle.

As shown in FIG. 2, a voltage sensor (voltage detector) 51 is connected to the switcher 22 to detect the voltage of each phase input from the motor driver 21. The voltage sensor 51 detects a voltage in a path between the output terminal of the motor driver 21 and the supply switch 41 of the switcher 22. The voltage sensor 51 is electrically connected to the switching controller 43. The voltage sensor 51 outputs the detected voltage value to the switching controller 43.

The rising timing of the voltage waveform means the timing when the PWM output changes from a low level to a high level. The falling timing of the voltage waveform means the timing when the PWM output changes from a high level to a low level. These timings can be easily acquired by comparing the voltage value detected by the voltage sensor 51 with a predetermined threshold value. The threshold value is, for example, a value greater than OV.

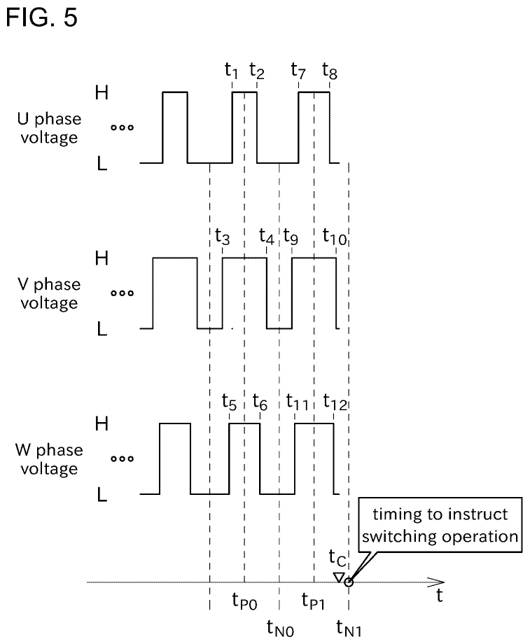

Next, with reference to FIG. 5, a specific method by which the switching controller 43 computes the timing included in the low-level period of the PWM output (specifically, the edge timing of the carrier cycle) will be described.

FIG. 5 shows an example of the voltage waveforms of each phase input from the motor driver 21 to the switcher 22. In the graph in FIG. 5, the horizontal axis is time, and the current time is indicated by t_{C}.

Consider the case where, at the current time t_{C}, the switching controller 43 acquires the rising time and the falling time for the two pulses that appeared in the voltage waveform of each phase in the most recent past, as t₁ to t₁₂. Focusing on the high-level periods (in other words, pulses) that appeared twice in the recent past, the respective central timing times t_{P0} and t_{P1} can be obtained by calculation based on the following equation using the rising and falling times t₁ to t₁₂.

$${t}_{P 0} = ( \frac{{t}_{1} + {t}_{2}}{2} + \frac{{t}_{3} + {t}_{4}}{2} + \frac{{t}_{5} + {t}_{6}}{2} ) / 3 = \frac{1}{6} {\sum }_{k = 1}^{6} {t}_{k}$$

$${t}_{P 1} = ( \frac{{t}_{7} + {t}_{8}}{2} + \frac{{t}_{9} + {t}_{10}}{2} + \frac{{t}_{11} + {t}_{12}}{2} ) / 3 = \frac{1}{6} {\sum }_{k = 7}^{12} {t}_{k}$$

This equation indicates that the two times t_{P0} and t_{P1} are determined as the average of the central timings acquired with respect to high-level periods of all three phases. This allows for a smaller error.

The length of the carrier cycle T can be computed as the difference between the two times t_{P0}, t_{P1}.

$$T = {t}_{P 1} - {t}_{P 0}$$

Time t_{N0}, which bisects the center timing t_{P0}, t_{P1} of the two high-level periods, is always included in the low-level period. This time t_{N0} means the time when the carrier cycle including the current time t_{C} started.

$${t}_{N 0} = \frac{{t}_{P 0} + {t}_{P 1}}{2}$$

The switching controller 43 determines the time tri at which the carrier cycle containing the current time t_{C} ends as the timing to instruct the supply switch 41 and the short-circuit switch 42 to perform the switching operation. This time t_{N1} is a time that is later than the above time to by a carrier cycle length T.

$${t}_{N 1} = {t}_{N 0} + T = \frac{3 {t}_{P 1} - {t}_{P 0}}{2}$$

Summarizing above, the time t_{N1} of the timing at which switching should be instructed to the supply switch 41 and the short-circuit switch 42 is expressed by the following equation.

$${t}_{N 1} = \frac{1}{4} {\sum }_{k = 7}^{12} {t}_{k} - \frac{1}{12} {\sum }_{k = 1}^{6} {t}_{k}$$

The switching controller 43 outputs the appropriate signals to the supply switch 41 and the short-circuit switch 42 to switch when the time tri as the computed switching timing arrives. This allows the supply switch 41 and the short-circuit switch 42 to be switched at the appropriate timing, thereby preventing the generation of noise and surges, etc.

If the control cycle of the PWM and the switching cycle of the switcher 22 are hypothetically misaligned, the PWM that should be output to one motor 23 may be output to another motor 23 by mistake. The configuration of this embodiment can prevent such erroneous output.

If the duty ratio of the PWM output is close to 0% or close to 100% in one or more of the three phases, it may not be possible to properly acquire the rise timing or the falling time of the pulse that appears in that phase, for example due to time resolution. Considering this, the switching controller 43 uses only the phase whose duty ratio is in a predetermined intermediate range (for example, 10% or more and 90% or less) among the three phases to compute the time t_{N1} for the timing to indicate switching. This allows the time t_{N1} as the timing to indicate switching to be obtained in a stable manner. The effective waveforms of the PWM outputs of the three phases are usually sinusoidal waves whose phases differ by 120°. Therefore, the duty ratios of all three phases do not deviate from the intermediate range described above at the same time.

The switching controller 43 can be provided in the motor driver 21, and the switching controller 43 can be modified to switch the supply switch 41 and the short-circuit switch 42 of the switcher 22 at a timing based on signals in the motor driver 21. The motor driver 21 is the device performing the PWM control. Therefore, if the switching controller 43 is provided in the motor driver 21, it is easy for the switching controller 43 to acquire the predetermined timing where all three phases are in the low-level period. However, in this case, the motor driver 21 must be specially configured in terms of both hardware and software in order to generate the appropriate signals for switching and supply them to the switcher 22 based on the internal signals (for example, carrier waveform) of the motor driver 21. Thus, it becomes difficult to employ existing motor drivers that are widely used.

In this regard, in this embodiment, the switching controller 43 controls the supply switch 41 and the short-circuit switch 42 to switch at appropriate timings based on the output waveform of the motor driver 21. Therefore, the widely used and inexpensive motor driver 21 can be employed as is, reducing the overall cost.

As described above, the motor system 1 of this embodiment includes the plurality of motors 23, the motor driver 21, and the switcher 22. The motor driver 21 generates and outputs the drive waveform to make the plurality of motors 23 generate the driving force by PWM control. The switcher 22 selectively switches the target motor, to which the electric power output by the motor driver 21 is supplied, among the plurality of motors 23. The switcher 22 is controlled by the switching controller 43 so that the target motor is cyclically switched among the plurality of motors 23. The carrier cycle of the PWM control includes the high-level period during which the PWM output is high level and the low-level period during which the PWM output is low level. The switching controller 43 controls the switcher 22 so that the switcher 22 switches the target motor during the low-level period.

This effectively prevents noise and surges, etc. from being generated during the switching operation of the switcher 22.

In the motor system 1 of this embodiment, the switching controller 43 controls the switcher 22 so that the switcher 22 switches the target motor at a timing (at time t_{N1}) where the phase of the carrier cycle is 180° different from the central timing of the high-level period.

This allows the switcher 22 to perform the switching operation at precise timing in relation to the PWM control.

In the motor system 1 of this embodiment, the switching controller 43 controls the switcher 22 so that the target motor is switched at each predetermined switching cycle. The carrier cycle of the PWM control and the switching cycle are synchronized.

This allows the switcher 22 to perform the switching operation at precise timing in relation to the PWM control.

The motor system 1 of this embodiment includes the voltage sensor 51 that detects the voltage output from the motor driver 21. The switching controller 43 determines the switching timing (timing at time t_{N1}) included in the low-level period based on the detection result of the voltage sensor 51. The switching controller 43 controls the switcher 22 so that the switcher 22 switches the target motor at the switching timing.

This allows the switcher 22 to perform the switching operation at precise timing in relation to the PWM control, without requiring the motor driver 21 to be specially configured.

In the motor system 1 of this embodiment, each of the plurality of motors 23 includes coils corresponding to three phases. The motor driver 21 performs the PWM control for each of the coils of three phases. The switching controller 43 determines, for at least one of the three phases, the central timing (time t_{P0}) of the first high-level period when the PWM output is high level and the central timing (time t_{P1}) of the second high-level period when the PWM output is high level next to the first high-level period. The switching controller 43 determines the switching timing based on these central timings.

This allows a predetermined timing included in the low-level period to be acquired as the switching timing.

In the motor system 1 of this embodiment, the switching controller 43 determines, for all three phases, the central timing (time t_{P0}) of the first high-level period when the PWM output is high level and the central timing (time t_{P1}) of the second high-level period when the PWM output is high level next to the first high-level period. The switching controller 43 determines the switching timing based on the central timings determined for all three phases.

This allows the switching timing to be stably acquired even in situations where the motor driver 21 performs PWM output at various duty ratios for each phase.

In the motor system 1 of this embodiment, the switching controller 43 controls the switcher 22 so that the switcher 22 switches the target motor during the period when the PWM output is low level for all three phases.

This effectively prevents noise, surges, and the like from being generated during the switching operation of the switcher 22, in all phases where PWM control is performed.

While some preferred embodiments of the present invention have been described above, the foregoing configurations can be modified, for example, as follows. The modification can be singly made and any combination of several modifications can be made.

It is also possible for the switching controller 43 to monitor the voltage waveforms of only one or two of the three phases to compute the time t_{N1} at which switching should be instructed.

The current sensor 35 can be omitted.

The timing at which the high-level and low-level periods appear can be determined to be any phase in the carrier cycle.

The timing at which the supply switch 41 and the short-circuit switch 42 perform the switching operation does not necessarily have to be at a timing where the phase of the carrier cycle is 180° different from the central timing of the high-level period, as long as it is included in the low-level period.

The carrier cycle of the PWM control and the switching cycle described above do not have to be synchronized.

The switching cycle of the switcher 22 is not limited to four cycles of the carrier cycle of the PWM control as in the example in FIG. 4, but can be one cycle, two cycles, three cycles, five cycles, etc.

The motor driver 21 and the switcher 22 may be realized in physically separate devices or in one device.

The maximum number of motors 23 to which the electric power output by the motor driver 21 can be distributed by switching the switcher 22 is predetermined. A number of motors 23 that exceeds this maximum number may be provided. In this configuration, the target motor is switched only among the motors 23 belonging to the target motor group, not among all of the motors 23. The maximum number of motors 23 that can belong to the target motor group is equal to the maximum number mentioned above. Depending on the situation, each of the motors 23 is assigned to belong to the target motor group and de-assigned. This assignment and de-assignment process is performed dynamically by the assigner, not shown. The hardware to realize the assigner may be provided in any of the motor driver 21, the switcher 22, and the controller 10.

With respect to switching the target motor, the switching controller 43 has the following three functions. (1) Determining the motor 23 to be the new target motor. (2) Determining the timing when to switch the target motor. (3) Generating and outputting a switching signal indicating the motor to be switched and the timing. The hardware to realize some or all of these functions may be arranged in the motor driver 21 or the controller 10.

From the above described embodiments and their modifications, at least the following technical ideas can be understood.

(Item 1) A motor system comprising:
a plurality of motors;
a motor driver that generates and outputs a drive waveform to make the plurality of motors generate a driving force by PWM control; and
a switcher for selectively switching a target motor, to which electric power output by the motor driver is supplied, among the plurality of motors, wherein
the switcher is controlled by a switching controller so that the target motor is cyclically switched among the plurality of the motors,
a carrier cycle of the PWM control includes a high-level period during which PWM output is high level and a low-level period during which the PWM output is low level, and
the switching controller controls the switcher so that the switcher switches the target motor during the low-level period.

(Item 2) The motor system according to item 1, wherein
the switching controller controls the switcher so that switcher switches the target motor at a timing where a phase of the carrier cycle differs by 180° with respect to a central timing of the high-level period.

(Item 3) The motor system according to item 1 or 2, wherein
the switching controller controls the switcher so that the target motor is switched at each predetermined switching cycle, and
the carrier cycle of the PWM control and the switching cycle are synchronized.

(Item 4) The motor system according to any one of items 1 to 3, comprising
a voltage detector detecting a voltage output from the motor driver, wherein
the switching controller determines a switching timing included in the low-level period based on a detection result of the voltage detector, and controls the switcher so that the switcher switches the target motor at the switching timing.

(Item 5) The motor system according to item 4, wherein
each of the plurality of motors includes coils corresponding to a plurality of phases,
the motor driver performs the PWM control for each of the coils of the plurality of phases,
the switching controller determines a central timing of the past high-level period of the PWM output for at least one of the plurality of phases, and
the switching controller determines the switching timing based on the central timing.

(Item 6) The motor system according to item 5, wherein
the switching controller determines a central timing of the past high-level period of the PWM output for two or more of the plurality of phases, and
the switching controller determines the switching timing based on the central timings determined for two or more phases.

(Item 7) The motor system according to any one of items 1 to 6, wherein
each of the plurality of motors includes coils corresponding to a plurality of phases,
the motor driver performs the PWM control for each of the coils of the plurality of phases, and
the switching controller controls the switcher so that the switcher switches the target motor during a period when the PWM output is low level for all of the plurality of phases.

### DESCRIPTION OF THE REFERENCE NUMERALS

1 Motor system
21 Motor driver
22 Switcher
23 Motor
43 Switching controller
51 Voltage sensor (voltage detector)

1-7. (canceled)

8. A motor system comprising:
a plurality of motors;
a motor driver that generates and outputs a drive waveform to make the plurality of motors generate a driving force by PWM control; and
a switcher that selectively switches a target motor, to which electric power output by the motor driver is supplied, among the plurality of motors, wherein
the switcher is controlled by a switching controller so that the target motor is cyclically switched among the plurality of the motors,
the electric power output by the motor driver is supplied only to the target motor among the plurality of motors connected to the switcher,
a carrier cycle of the PWM control includes a high-level period during which PWM output is high level and a low-level period during which the PWM output is low level, and
the switching controller controls the switcher so that the switcher switches the target motor during the low-level period.

9. The motor system according to claim 8, wherein the switching controller controls the switcher so that the switcher switches the target motor at a timing where a phase of the carrier cycle differs by 180° with respect to a central timing of the high-level period.

10. The motor system according to claim 8, wherein
the switching controller controls the switcher so that the target motor is switched at each predetermined switching cycle, and
the carrier cycle of the PWM control and the switching cycle are synchronized.

11. The motor system according to claim 8, comprising
a voltage detector detecting a voltage output from the motor driver, wherein
the switching controller determines a switching timing included in the low-level period based on a detection result of the voltage detector, and controls the switcher so that the switcher switches the target motor at the switching timing.

12. The motor system according to claim 11, wherein
each of the plurality of motors includes coils corresponding to a plurality of phases,
the motor driver performs the PWM control for each of the coils of the plurality of phases,
the switching controller determines a central timing of the past high-level period of the PWM output for at least one of the plurality of phases, and
the switching controller determines the switching timing based on the central timing.

13. The motor system according to claim 12, wherein
the switching controller determines a central timing of the past high-level period of the PWM output for two or more of the plurality of phases, and
the switching controller determines the switching timing based on the central timings determined for two or more phases.

14. The motor system according to claim 8, wherein
each of the plurality of motors includes coils corresponding to a plurality of phases,
the motor driver performs the PWM control for each of the coils of the plurality of phases, and
the switching controller controls the switcher so that the switcher switches the target motor during a period when the PWM output is low level for all of the plurality of phases.
